(19) United States
(12) Patent Application Publication
(10) Pub. No.: US 2004/0188544 A1
(43) Pub. Date: Sep. 30, 2004

(54) Water misting system and method

(76) Inventor: Seann Pavlik, Ft. Lauderdale, FL (US)

Correspondence Address: NIXON & VANDERHYE, PC, 1100 N GLEBE ROAD, 8TH FLOOR, ARLINGTON, VA, 22201-4714, US

(21) Appl. No.: 10/678,173

(22) Filed: Oct. 6, 2003

Related U.S. Application Data
(63) Continuation-in-part of application No. 10/396,798, filed on Mar. 26, 2003.
(63) Continuation-in-part of application No. 10/632,895, filed on Aug. 4, 2003.

(51) Int. Cl. B05B 15/00

(52) U.S. Cl. 239/289

(57) ABSTRACT

A misting system uses elements having multiple functions, and integrates the mist producing nozzles and conduits with other components so that the misting system does not detract from the aesthetics of the surrounding environment. The misting system preferably uses fresh water under high pressure (200-1000 psi), and supplies mist droplets about 5-100 microns in diameter to effect evaporative cooling of the surrounding area. The nozzles are screw-threaded into conduits or nozzle extensions, and preferably use orifices having a diameter of about 0.2-0.5 mm. The misting system may be aesthetically integrated into a boat (or other watercraft) canopy frame, a boat superstructure, a boat rail, a ceiling panel, and/or a light fixture. The nozzle extensions may be modified to have external screw threads which cooperate with a nut or other structure for mounting. The misting nozzle may be used with a supporting vertical pipe with T-piece for landscaping or agricultural misting.

### CROSS-REFERENCE TO RELATED APPLICATIONS

This application is a continuation-in part of each of applications Ser. No. 10/396,798 filed Mar. 26, 2003 and Ser. No. 10/632,895 filed Aug. 4, 2003.

### BACKGROUND AND SUMMARY OF THE INVENTION

There are many situations where it is desired to provide evaporative cooling in an area, or of people or other living beings [such as plants or animals] within the area. For that purpose low pressure (under 100 psi), medium pressure (100-under 200 psi), and high pressure (200+ psi) systems are commercially available. However, most such systems are constructed without aesthetics in mind, and provide a number of non-aesthetic components in clear view. Also, most of such systems are provided as add-on structures, and are not successfully integrated into already existing or common structures, for a particular environment, and may be exposed to damage or corrosion.

For example, in the marine environment, U.S. Pat. Nos. 5,628,273, 6,175,969, and 6,263,826 all provide for evaporate cooling associated with watercraft, but do so in a way that has significant drawbacks associated therewith. For example in U.S. Pat. No. 5,628,273 while the misting apparatus is associated with a boat canopy frame, hoses connected to misting nozzles are strapped onto a pre-existing canopy frame component, providing a non-aesthetic construction that also has the disadvantage of being exposed to damage or corrosion. Similarly in U.S. Pat. No. 6,175,969 flexible water tubing is connected to misting nozzles and typically to a clip or bracket which is in turn connected to the exterior of a frame element of a swimming pool or boat. In U.S. Pat. No. 6,263,826 the rubber tubing connected to a spray nozzle is partially protected by being disposed within an existing canopy hollow metal tubing support element. However, the nozzle necessarily is provided sticking above the canopy or on a bow portion of the watercraft, and sprays water picked up from the body of water on which the watercraft is traveling upwardly in a rain-like shower, rather than as a mist. None of these structures are adapted for anything other than low pressure systems (e.g. in the U.S. Pat. No. 6,175,969 patent the pressure is a maximum of about 50 psi), and therefore are limited to the inefficient cooling typically provided by conventional low pressure systems.

According to the present invention, a method and system are provided which have a number of advantages. Regardless of the environment in which the invention is used, it can provide high pressure (typically between about 200-1000 psi) misting, and therefore cools very efficiently. Also, the invention is aesthetic, not having component parts that are obtrusive. Also, by integrating the components of the misting system into already existing components in or adjacent to the area to be cooled, dual functionality is provided. This results in a reduction of the number of elements needed, as well as providing at least some mechanical and/or corrosion protection for components of the misting system.

While the invention has particular applicability and advantages in association with watercraft and in other marine environments, the invention is also applicable to a wide variety of other situations where cooling, aesthetics, and mechanical and/or corrosion protection are desired.

According to one aspect of the present invention there is provided a method of cooling a space or living beings within the space, the space defined at least in part by existing functional elements including at least one substantially liquid-tight passage-containing element [such as, but not limited to, a rigid hollow frame component or rail]. The method comprises: a) providing at least one misting nozzle in operative association with the substantially liquid-tight passage-containing element; and b) supplying liquid under pressure to flow through the existing substantially liquid-tight passage-containing element and confined thereby so that the liquid is supplied as a mist directly into the space through the nozzle to evaporatively cool the space or living beings within the space.

According to this aspect of the invention, a) and b) may be practiced using a hollow substantially rigid canopy frame component on a watercraft as the substantially liquid-tight passage-containing element. Alternatively, a) and b) may be practiced using a hollow substantially rigid rail or supporting frame on a watercraft as the substantially liquid-tight passage-containing element; or a) and b) may be practiced to provide the mist through a portion of a light fixture.

Preferably, b) is practiced by supplying fresh water under a pressure of between about 200-1000 psi [that is, in a high pressure system, which is most efficient]. Desirably, a) and b) are practiced to provide a mist of water droplets having a maximum cross-sectional dimension (e.g. diameter) of between about 5-100 microns in the space.

According to another aspect of the present invention there is provided a method of cooling a space, or humans within the space, on a watercraft in an aesthetically acceptable manner, by a) directly misting fresh water into the watercraft space as a mist of water droplets having a maximum cross-sectional dimension of between about 5-100 microns. Preferably, a) is practiced by supplying the water through an unobtrusive nozzle at a pressure of between about 200-1000 psi, and so that the source of the fresh water is not readily visible in the space. In one embodiment, a) is practiced to direct the mist downwardly into a space covered by a canopy on a deck portion of the watercraft, and in that case a) is further typically practiced by transporting the water directly through one or more hollow substantially rigid and water-tight frame elements supporting the canopy, and through a plurality of nozzles in communication with the hollow interior of the one or more frame elements.

When in the space the temperature is above 80 degrees F. and the relative humidity is above 80%, a) may be further practiced by chilling the water to a temperature between about 33-50 degrees F., and misting the chilled water into the space. The chilling may be done using conventional refrigeration or water chilling equipment, which is commercially available for use on boats.

Alternatively, a) may be practiced by supplying the mist from a nozzle mounted on a portion of a light fixture of the watercraft, or a) may be practiced by supplying the mist from a plurality of nozzles mounted on at least one of an otherwise functional substantially rigid hollow rail or superstructure frame element of the watercraft.

According to another aspect of the invention there is provided a misting system for supplying a mist of liquid into a space to cool the space or living beings within the space. The system comprises: A substantially water-tight passage-containing element which both defines a portion of the space and transports liquid to be sprayed directly into the space. A nozzle operatively connected to the substantially water tight element and positioned to spray a mist of liquid from the passage-containing element directly into the space. And a source of liquid under super-atmospheric pressure operatively connected to the passage-containing element.

The system may be mounted on a watercraft to supply a mist of liquid directly toward a deck portion of the watercraft. The passage-containing element may comprise a component of a frame for supporting a canopy, a rail, a superstructure frame element, or a light fixture. Preferably, the nozzle has at least one orifice with a diameter of between about 0.2-0.5 mm. The source of liquid under super-atmospheric pressure preferably comprises a source of fresh water at a pressure of between about 200-1000 psi [i. e. the system is high pressure], and operatively connected through a regulator to the passage-containing element.

The passage-containing element may comprise a substantially rigid and tubular element having a first end mounting the nozzle, a body having an exterior surface with external threading over at least a portion thereof, and a second end operatively connected to the source of liquid under super-atmospheric pressure, the external threading operatively engaging a structural element that in part defines the space. Alternatively, the structural element may comprise a light fixture (e.g. on a watercraft) substantially annular component, with an open interior of the annular component having an artificial light source therein. A plurality of the nozzles may be provided, each of which has a screw-threaded end which passes through a passage in the annular component, into a conduit connected to the source of liquid under super-atmospheric pressure. The nozzle may comprise a single head, or a multi-head, nozzle.

According to yet another aspect of the present invention, there is provided misting system comprising: A substantially rigid and liquid-tight hollow element capable of withstanding at least 100 psi of liquid flowing therein. At least one internally threaded opening formed in the element and having a land. A misting nozzle having an orifice-containing end and a conduit end, the conduit end having a shaft and a ledge, the shaft including an externally threaded portion dimensioned and configured to be screwed threaded into the at least one internally threaded opening. The misting nozzle externally threaded portion directly operatively engaging the internally threaded opening. And a seal operatively disposed between the land and the ledge.

The seal may comprise a ring of material which provides a substantially liquid-tight seal between the hollow element and the nozzle, such as an O-ring. Desirably the nozzle has at least one orifice with a diameter of between about 0.2-0.5 mm. The system also preferably further comprises a source of fresh water at a pressure of between about 200-1000 psi, and operatively connected through a regulator to the hollow element.

The hollow element may comprise a boat canopy frame element, a boat rail, or a boat superstructure element, and the nozzle is preferably positioned to mist water toward a deck area of a boat mounting the hollow element. The system may further comprise a plurality of the nozzles operatively connected to the hollow element, each nozzle supplying a mist of water droplets having a maximum cross-sectional dimension of between about 5-100 microns toward the boat deck.

It is the primary object of the present invention to provide an aesthetic and practical misting system and method having a wide variety of uses, including cooling deck areas on a boat. This and other objects of the invention will become from an inspection of the detailed description of the invention, and from the appended claims.

### BRIEF DESCRIPTION OF THE DRAWINGS

FIG. 1 is a side elevation view of an exemplary watercraft using a system, and practicing a method, according to the present invention;

FIG. 1A is an enlarged view of the tuna tower of the boat of FIG. 1;

FIG. 2 is a rear perspective view of an area of the boat of FIG. 1 covered by a canopy, and in which misting takes place;

FIG. 3 is an enlarged top perspective view of a portion of the bow of the boat of FIG. 1 showing an exemplary misting system according to the invention associated therewith;

FIG. 4 is an enlarged side view of the interconnection between a water supply line and canopy frame in an exemplary system according to the present invention;

FIG. 5 is a view like that of FIG. 4 only showing portions of the canopy and misting nozzles unobtrusively provided therein according to one embodiment of the present invention;

FIG. 6 is a schematic cross-sectional view taken along lines 66 of FIG. 5;

FIG. 7 is a side elevation view of a yacht or cruise ship utilizing the invention, and FIG. 8 is an enlarged portion of the aft section of the boat of FIG. 7 showing misting according to the present invention;

FIG. 9 is a bottom perspective view of a lighting fixture embodiment of a misting system for practicing misting methods according to the present invention;

FIG. 10 is an axial primarily cross-section, and partly elevation, view taken along lines 10-10 of FIG. 9;

FIG. 11 is a bottom plan view of the nozzle assembly of FIG. 10;

FIG. 12 is exploded perspective view of the lighting fixture of FIG. 9;

FIG. 13 is a side schematic view of an installation utilizing a plurality of the lighting fixtures of FIGS. 9-12 for cooling;

FIG. 14 is a bottom perspective view of a ceiling panel utilizing a plurality of misting nozzles according to the invention;

FIGS. 15 & 16 are views like those of FIGS. 7 and 8 only utilizing lighting fixtures like that of FIGS. 9-12 for providing misting of various areas thereof;

FIG. 17 is a view like that of FIG. 10 showing an alternative embodiment of nozzle and nozzle extension that may be provided in the practice of the present invention;

FIG. 18 is a side elevation view of another embodiment of nozzle and nozzle extension utilizable in the practice of the invention;

FIG. 19 is a side view, partly in cross-section and partly in elevation, of the assembly of FIG. 18 in association with a pressurized conduit for providing misting liquid; and

FIG. 20 is a perspective view of the assembly of FIG. 19 shown in use as a landscape or agricultural misting system.

### DETAILED DESCRIPTION OF THE DRAWINGS

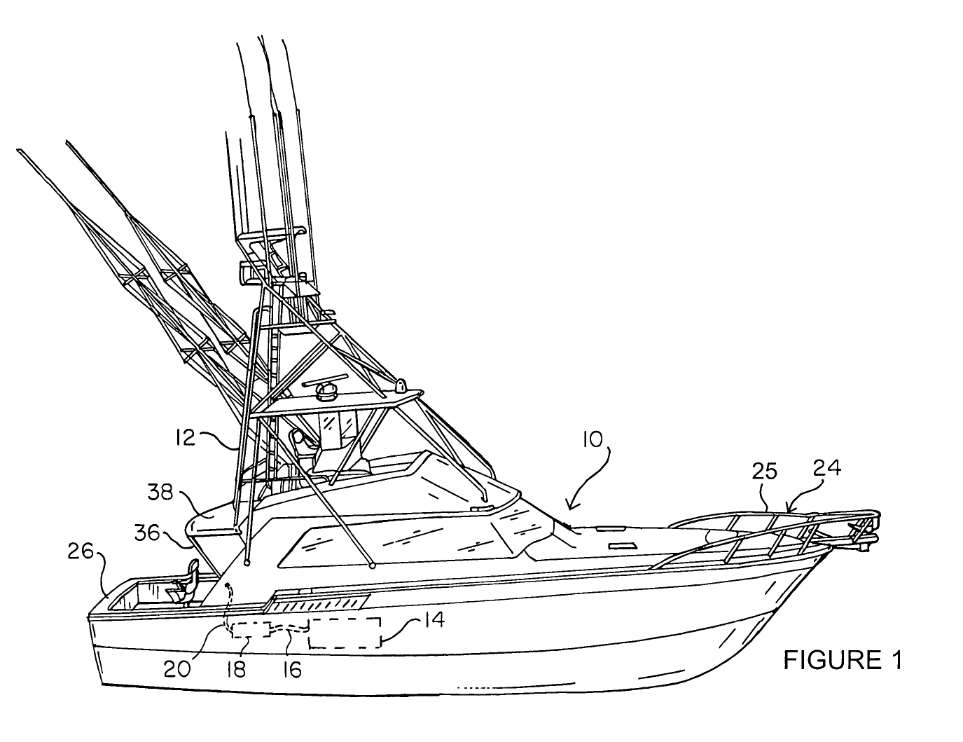

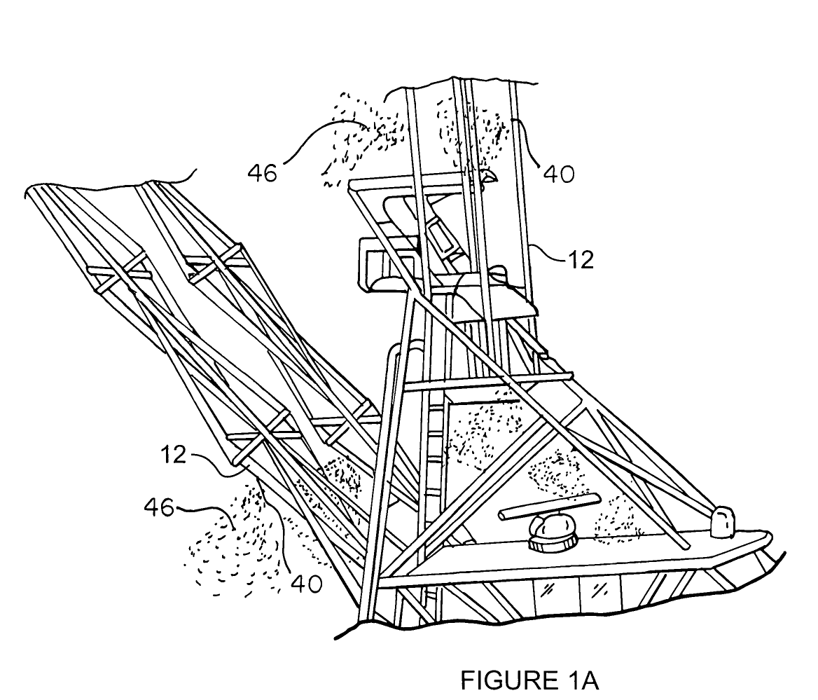

The exemplary watercraft illustrated in FIG. 1 is a fishing boat 10, having a tuna tower 12, or like superstructure. Shown in phantom at the bottom center of FIG. 1 is a reservoir 14 of water [preferably fresh drinking, or other potable, water]. The reservoir 14 is connected by a conduit 16 in operative fluid communication with a conventional pump/compressor 18. The pump 18 per se is not part of the invention, and any suitable pump or other device for pressurizing liquid [preferably to a pressure of about 200-1000 psi] may be provided. One suitable pressurizing device 18 is a Triplex Direct Drive Plunger Pump Model 2SF, sold by Cat Pumps of Minneapolis, Minn. However, the pump of U.S. Pat. No. 6,263,826, or the pump or pressurized SCUBA tank of U.S. Pat. No. 6,175,969, or any other suitable device may be provided, as long as it is capable of discharging liquid at a pressure of about 200-1500 psi.

The reservoir 14, conduit 16, pressurizing device 18, and any other conventional components provided therewith (such as a regulator and conduits), may comprise a source of liquid under super-atmospheric pressure for practicing the invention. While under some circumstances low or medium pressure may be used, preferably high pressure misting is employed in the practice of the invention. The source may be above or below the waterline of the boat 10. Though less desirable in most circumstances, instead of or in addition to a reservoir 14, a water intake (see U.S. Pat. Nos. 5,628,273 and 6,263,826) associated with the body of water in which the boat 10 is positioned, may be used as part of the source.

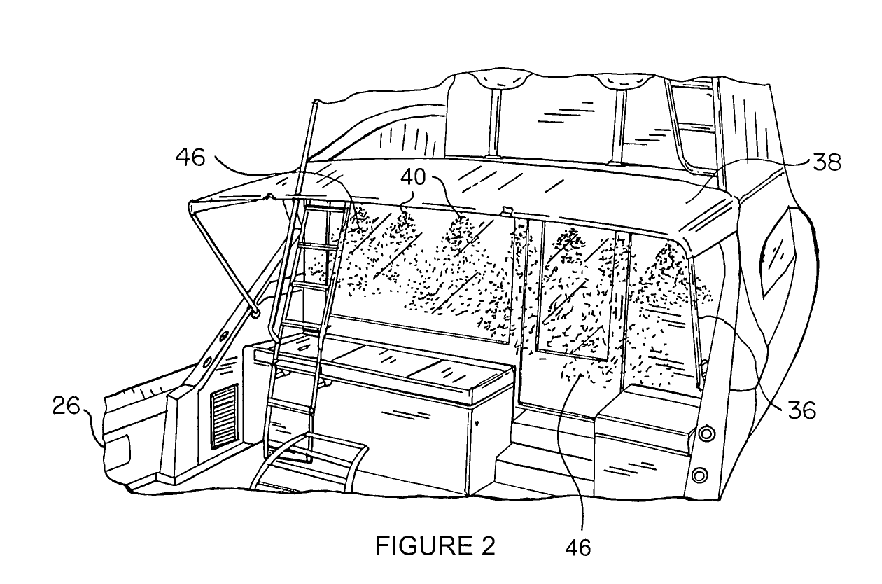

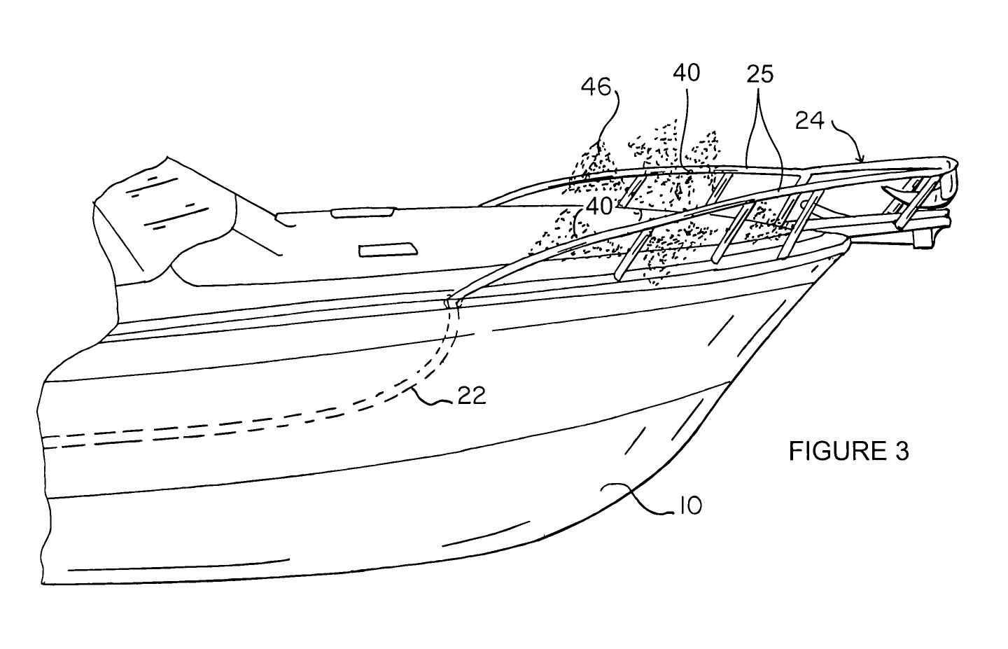

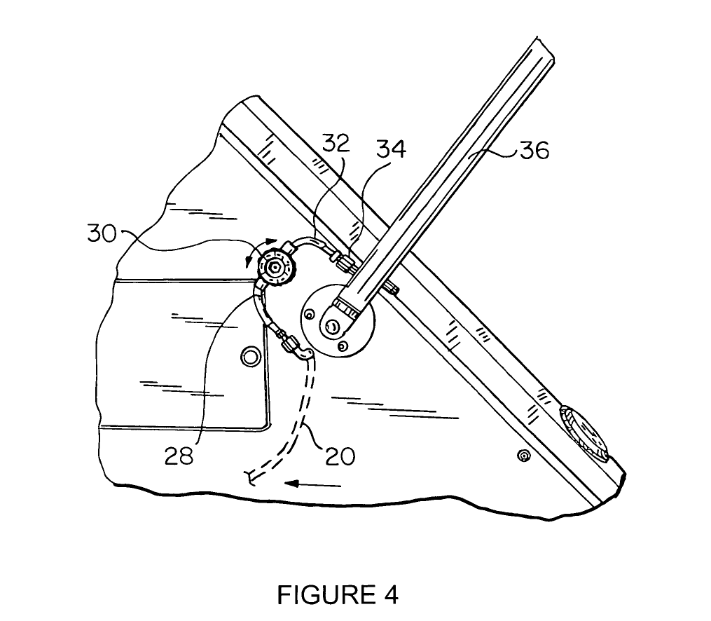

One or more pressurized output conduits 20 (FIGS. 1 and 4) and 22 (FIG. 3) may be provided from the pressurizing device 18 to the bow or fore area 24 of the boat 10 (see FIG. 3) and/or toward the stem or aft area 26 of the boat 10 (see FIGS. 1 and 2). In the exemplary embodiment of FIG. 4, the pressurized conduit 20 (preferably of a substantially corrosion-resistant, water-tight, high strength material such as stainless steel or aluminum) is connected by piping 28 to a regulator 30. The regulator 30 may be a conventional unloader valve and/or flow gauge, or any other conventional device for regulating the flow of liquid into the conduit 32 on the opposite side of the device 30 from the conduit 28. The regulator 30 may be operated manually when cooling is needed, and/or automatically [e.g. on a timer, or in response to sensing of environmental conditions—such as temperature and humidity—in the area to be cooled]. The conduits 28, 32 may be made of the same type of materials as the conduit 20.

In order to provide the minimum number of parts (with associated cost and simplicity advantages), aesthetics, and mechanical and/or corrosion functionality, preferably the actual misting system operatively associated with the pump 18, etc., or other source of liquid under pressure, includes a frame element 36. The frame element 36 is a liquid passage-containing element that has functionality not associated with the misting system. That is, the element 36 supports in whole or in part the canopy or awning 38 (FIGS. 1, 2, & 5). Frame element 36 is typically a hollow substantially rigid, pressurizable, and water-tight element, such as a tube of corrosion-resistant metal like aluminum or stainless steel. Water under pressure passes through conventional fitting 34 connected to conduit 32 directly into the hollow pressurizable interior (see FIG. 6) of the canopy frame element 36. Element 36 is part of a tubular framework which supports the canopy 38. Similar elements can provide spokes of an umbrella.

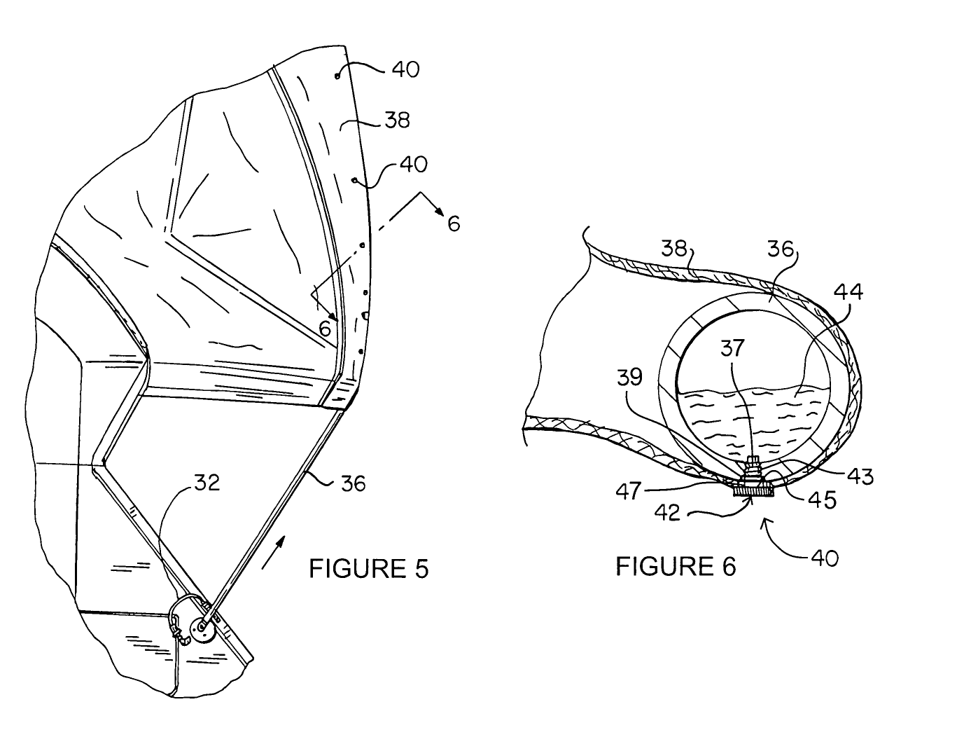

Within at least one element 36 of the tubular framework which supports the canopy 38 are a plurality of misting nozzles 40 (see FIGS. 5 & 6). The nozzles 40 may be of the type sold by Fogco System, Ltd. of Newcastle-on-Tyne, UK, and preferably are of metal, such as brass or steel. The element 36 has at least one internally threaded opening 37 (see FIG. 6) formed therein and has a land 39, and contains water 44. In FIG. 6 the water 44 is shown substantially unpressurized; when the element 36 is pressurized (e.g. preferably to about 200-1000 psi) the element 36 will be substantially filled with water.

Each misting nozzle 40 has an orifice-containing end 42 and a conduit end 41, the conduit end 41 having a shaft 43 and a ledge 45. The shaft 43 includes an externally threaded portion (see FIG. 6) dimensioned and configured to be screwed threaded into the internally threaded opening 37, so that the misting nozzle externally threaded portion of shaft 43 directly operatively engages the internally threaded opening 37. The conventionally available nozzles 40 include a seal 47 operatively disposed between the land 39 and the ledge 45. Conventionally the seal 47 comprises a ring of material [e.g. an O-ring] which provides a substantially liquid-tight seal between the hollow element 36 and the nozzle 40, such as polytetrafluoroethylene, natural or synthetic rubber, or one of a variety of plastics.

The orifice(s) in the end 42 of nozzle 40 preferably has a diameter of between about 0.2-0.5 mm [0.008-0.02 inches]. When supplied with water under a pressure of between about 200-1000 psi [1000-5000 cm Hg], the orifice(s) of nozzle 40 delivers a mist 46 (see FIGS. 1A, 2, 3 & 8) of water droplets having a maximum cross-sectional dimension (e.g. diameter) of between about 5-100 microns. This provides maximum flash evaporative cooling (the latent heat of evaporation of water is about 600 calories/gm), without allowing significant water droplet accumulation on the skin of a person in the space into which the mist 46 is supplied. This means that the mist 46 within about a two-three meter distance from each nozzle 40 may provide cooling of as much as 30 degrees F. [about 16 degrees C.].

FIG. 2 shows a space underneath a canopy 38 in an aft section of boat 10 defined in part by the frame elements 36 into which space the mist 46 is delivered. The mist 46 moves downwardly toward the deck 27 of the boat 10. In the FIG. 1A embodiment, the superstructure 12 includes hollow elements similar to the element 36 into which water under pressure is provided, and into which nozzles 40 are screwed. The mist 46 is emitted from the superstructure 12 toward the deck of the boat 10, or other areas in which humans may be positioned. In the FIG. 3 embodiment, the conventional hollow corrosion-resistant material [e.g. aluminum or stainless steel] rail 25 adjacent the bow 24 is supplied with water under pressure through conduit 22. The water moves through nozzles 40 screwed into openings [like opening 37] in the rail 25 to provide mist 46 adjacent the bow 24.

Supplying ambient temperature water for misting 46 is typically desirable. However, when the relative humidity in the area being misted is greater than about 80%, and the temperature is above about 80 degrees F. (e. g. above 90), to provide optimum cooling it may be desirable to use chilled water for misting. The water may be chilled by any suitable conventional devices, such as marine chillers or refrigerators, to between about 33-50 degrees F., before misting 46 into the area to be cooled. Chilling may be initiated manually, or in response to sensing of environmental conditions [e.g. a relative humidity of over 80% and a temperature of over 85 degrees F.].

While a single head nozzle 40 is illustrated in FIG. 6, it is to be understood that in some environments a conventional multi-head (e.g. five head) nozzle may be provided, as long as it is aesthetically acceptable.

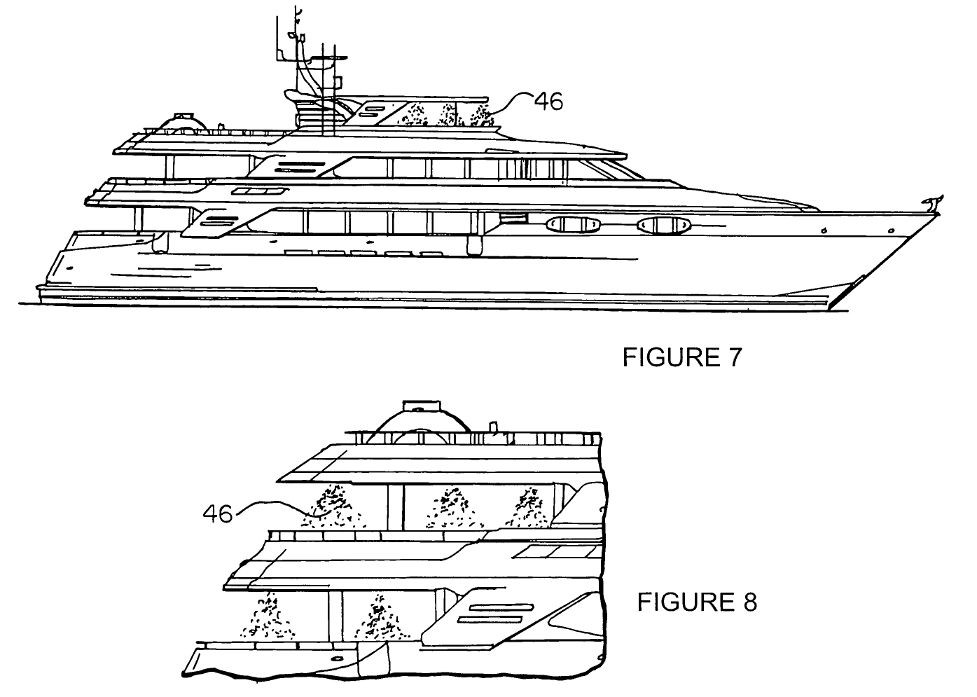

FIGS. 6 and 7 show an embodiment of the invention where the watercraft is a relatively large yacht or cruise ship. A single or multiple reservoirs 14 and/or pressurizing devices 18 may be used to provide the water for misting to different levels of the craft of FIGS. 6 & 7 to provide misting 46 at various locations thereof.

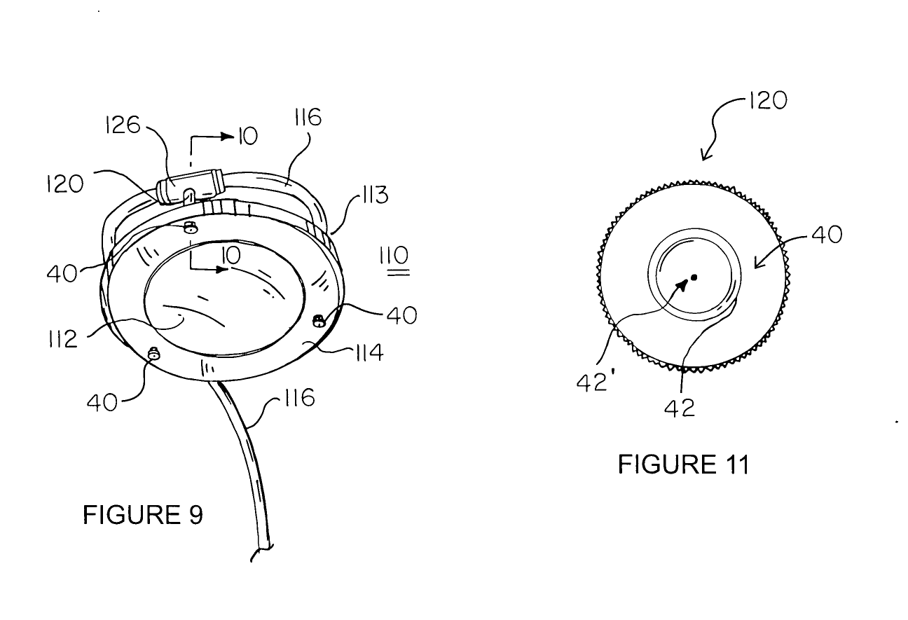

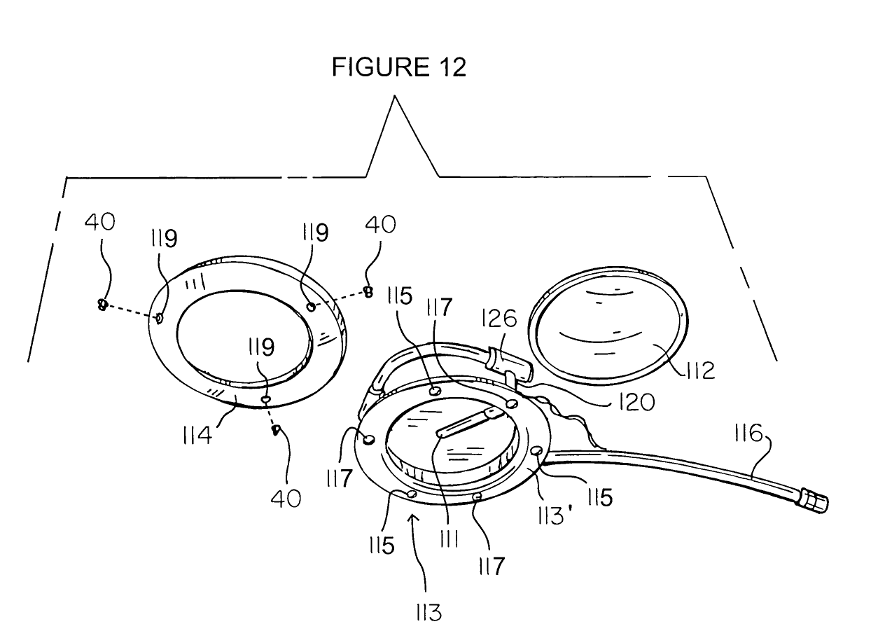

FIGS. 9-12 show an embodiment in which the dual functionality of the misting system is included in a light fixture 110, which may be used on a watercraft or in any other suitable environment. The fixture 110 includes a conventional transparent lens 112 positional within the casing 113 to cover a conventional artificial light source [e.g. light bulb 111—see FIG. 12]. The casing 113 includes a plurality of openings 115 in an annular flange 113′ thereof which receive any suitable conventional fasteners (not shown) which attach the casing 113 to any suitable desired structure, such as in a pavilion, gazebo, watercraft deck-overlying portion, etc. The casing flange 113′ also includes a plurality of openings 117 in which are press-fit, interference-fit, or screwed a plurality of conventional or modified nozzle extenders 120 available from Fogco System, Ltd. for cooperation with nozzles 40.

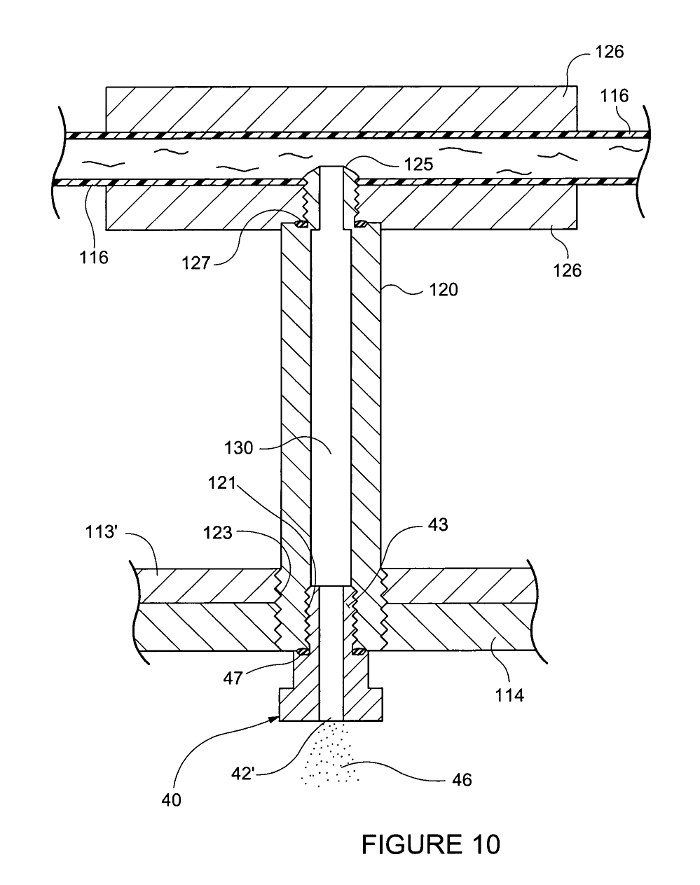

The fixture 110 also includes a passage-containing element 114, typically of metal (e.g. stainless steel) or substantially rigid plastic. In the drawings, element 114 (in particular see FIG. 12) is annular, surrounding lens 112, and has a plurality of passages 119 provided therein, each passage 119 aligned with an extension 120 to be in operative fluid cooperation therewith. The nozzles 40 have the shafts 43 thereof passed through the passages 119 to hold the element 114 to the casing flange 113′, with the nozzles 40 in fluid connection with the extensions 120, a seal 47 (see FIG. 10) provided therebetween. FIG. 10 shows the externally threaded shaft 43 of the nozzle 40 engaging the conventional interior screw threads 121 of the extension 120.

FIG. 10 shows an exterior screw-threading 123 of the extension 120 according to the invention engaging a cooperating screw thread in the casing flange 113′. However, instead of a screw thread, the extension 120 may have conventional axial serrations, or other surface manifestations, which can provide a press or interference fit with the casing flange 113′ or other structure to which the extension 120 is attached. FIG. 11 shows an orifice 42′ in the orifice-containing end 42 of the nozzle 40 when the nozzle 40 is screw-threaded into an extension 120. The size of the orifice 42′ is preferable between about 0.2-0.5 mm.

The end of the extension 120 opposite the nozzle 40 (see FIG. 2 in particular) has a screw threaded nipple 125 and a sealing ring 127. The screw threading of nipple 125 engages like screw-threading in a conventional fitting 126 of a conduit 116 containing liquid under pressure, while the sealing ring 127 provides a substantially water-tight seal with the outer surface of the fitting 126 or conduit 116. The conduit 116 may be bendable, but of relatively rigid material, such as a hard but workable plastic capable of transporting liquid under high pressure. The fitting portion 126 may be of metal, such as stainless steel, and the extension 120 also is preferably of metal, such as brass or steel. The conduit 116 is connected to the reservoir 14 and/or pressurizing device 18 by any suitable device, such as described with respect to the FIG. 4 embodiment.

In use of the FIGS. 9-12 embodiment, fasteners are passed through the openings 115 in the casing flange 113′ to attach the casing 113 to a boat misting area-defining structure above a deck portion, or in any other suitable location. The lens 112 covers the bulb 111, and the bulb 111 is connected to a source of electricity. The annular plate 114 is held onto the casing 113 by passing nozzle 40 shafts 43 into screw threaded engagement with the interior screw threading of the extensions 120. The nozzle shafts 43 thus pass through the passages 119 and openings 117 so that the nozzles 40 hold the annular element 114 into operative association with the casing 113. The extensions 120, through fittings 126, connect the nozzles 40 with the pressurized water in the conduit 116. Water under pressure (e.g. 200-1000 psi) flows from conduit 116 through the hollow interior 130 of extensions 120 through the orifices 42′ of the nozzles 40 to provide mist 46 into an area to be cooled.

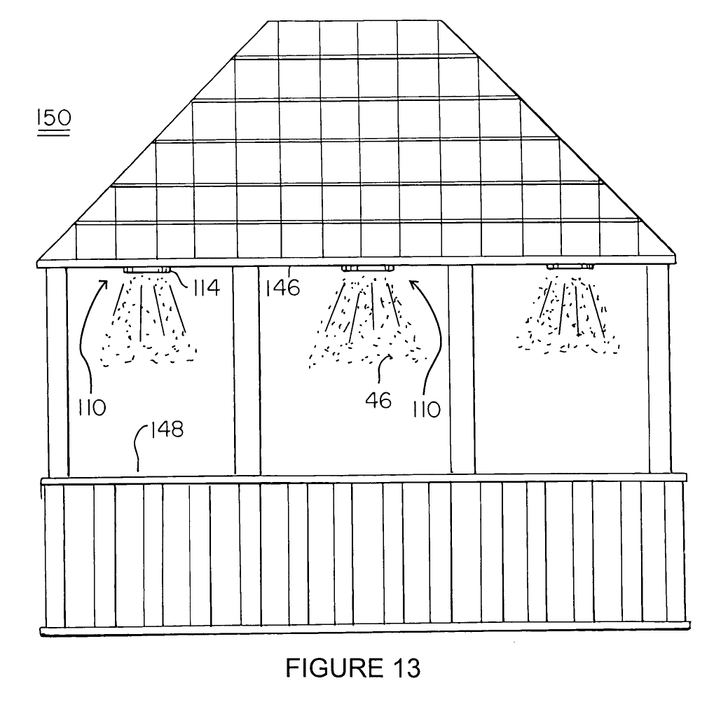

FIG. 13 schematically illustrates an embodiment in which lighting fixtures 110 are mounted in a ceiling 146 of a porch 148 of a building 150. Mists 46 cascade downwardly from the light fixtures 110 when pressurized water is provided thereto, cooling the area of the porch 148.

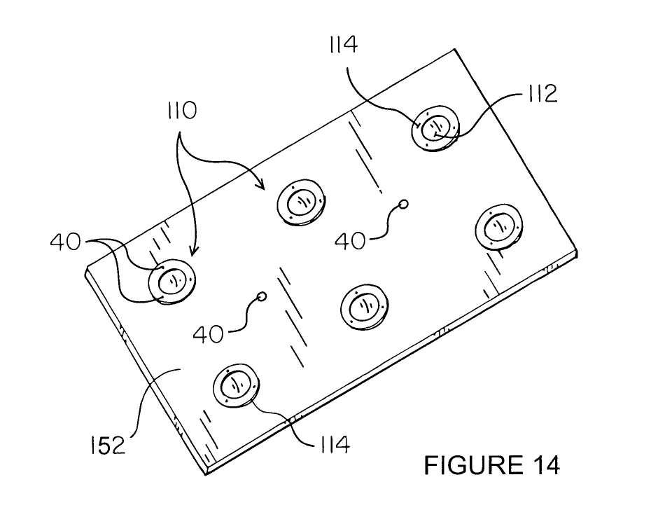

FIG. 14 shows an embodiment in which a plurality of the fixtures 110 are provided in a ceiling panel 152. In some embodiments nozzles 40 alone may be screwed into extensions 120 provided on the opposite side of a ceiling panel 152 where lighting is not necessary. Or, a plate surrounding a nozzle [such as shown in pending U.S. Design applications Ser. No. 29/185718 filed Jul. 3, 2003 and Ser. No.29/185719 filed Jul. 3, 2003] can be secured to the panel 152 with the nozzle 40 threaded through the plate to an extender 120 on the other side thereof. Alternatively both nozzles 40 per se (with or without surrounding plates) and fixtures 110 may be provided in the same ceiling panel 152.

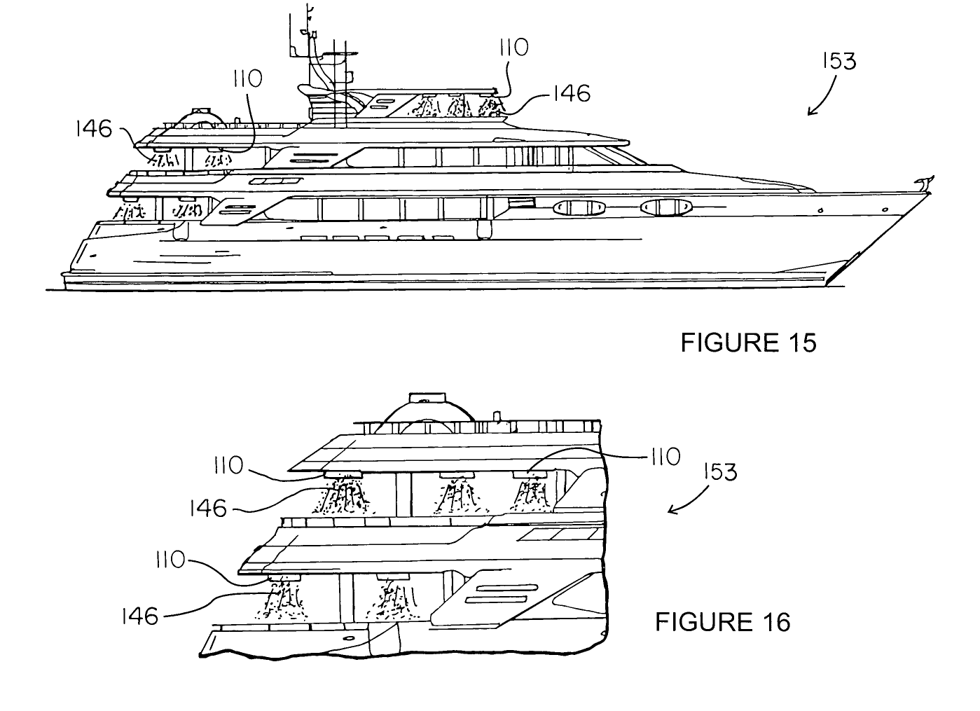

FIGS. 15 and 16 show light fixtures 110 provided in exterior portions of a yacht 153 over deck portions on multiple levels of the ship 153 to provide cooling of those deck portions.

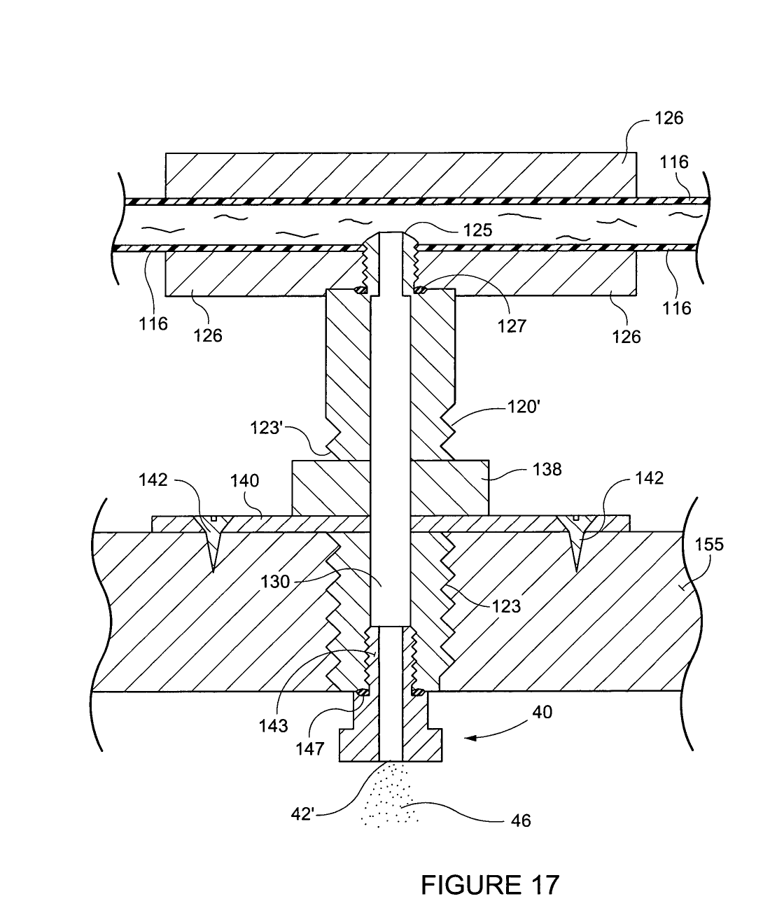

FIG. 17 shows an embodiment in which an extension 120′ has an extensive exterior screw-threaded portion 123′ thereof which may be in screw-threaded engagement with a wood, or similar material, support 155, or may pass through a non-threaded opening in the support 155 and be held in place by a nut 138. Wood screws, or like fasteners, 142 may hold a washer 140 in contact with the support 155. The nut 138 abuts the washer 140. The nozzle 40 unobtrusively extends from the support 155, connected to the extension 120′ as in the FIG. 10 embodiment.

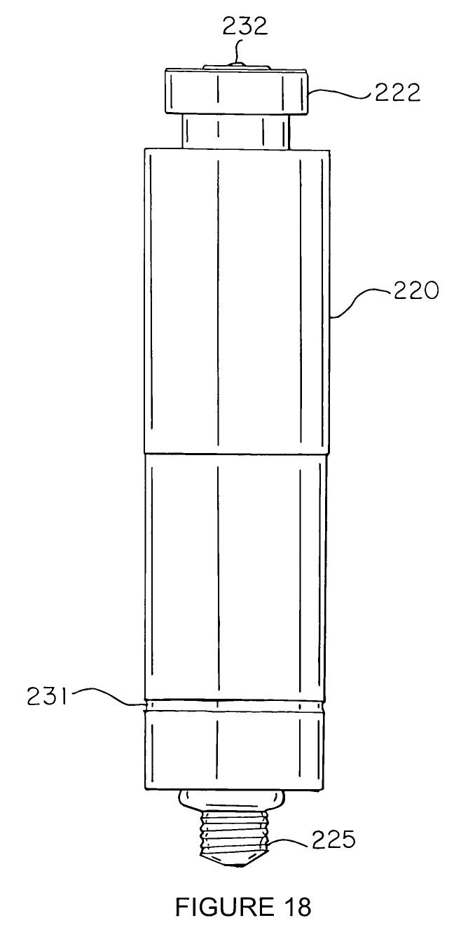

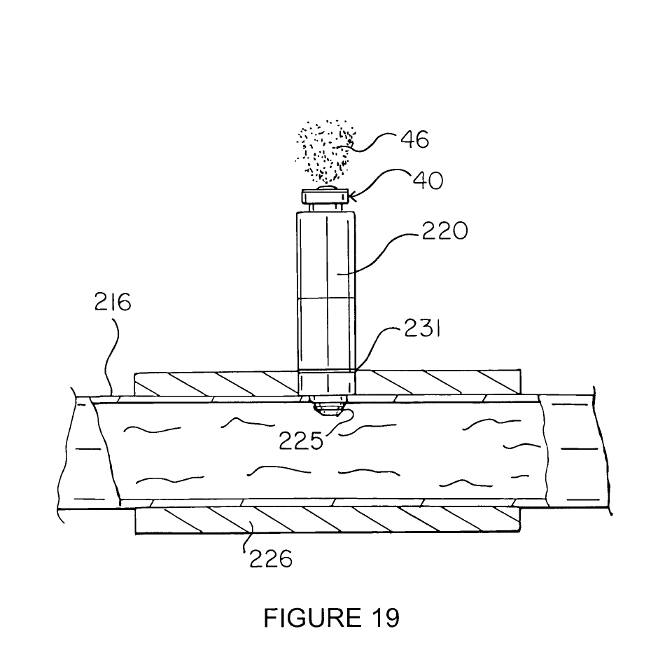

In the FIG. 18 embodiment, the nozzle 40 is connected to an extension 220 which has a circumferential channel 231, and a nipple 225. As seen in FIG. 19, the purpose of the channel 231 is to snap-fit the extension 220 into a conventional slip lock fitting 226 which is connected to a high pressure conduit 216. The extension 220 and the nozzle 40 extend substantially upwardly from the conduit 216.

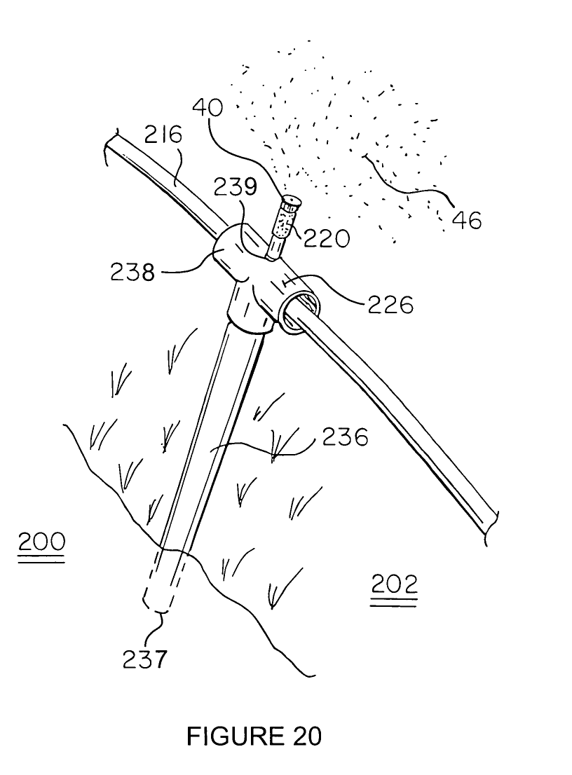

One application of the FIG. 18/19 embodiment is the landscape or agricultural misting system shown in FIG. 20. In FIG. 20 a substantially vertical pipe 236 (e.g. of relatively hard and inexpensive plastic such as pvc) extends upwardly out of the ground 200. Pipe 236 has a first end 237 that is preferably tapered for easier insertion into the ground, and a second end 238 comprising a T-shaped piece, also of relatively rigid and inexpensive plastic. The T-piece 238 has a substantially vertical opening 239 therein large enough to fit the extender 220, but preferably only slightly larger than the outside diameter of extender 220 so as to provide some support therefor. The conventional metal coupling 226 is substantially centered within the T-piece 238 (see the cut-away portion of 238 which reveals the fitting 226 in the interior). The conduit 216 (preferably of relatively rigid but bendable plastic capable of transporting water under a pressure of up to 1500 psi) also passes through the T 238. The extender 220 passes through the opening 239 and may be slip fit into coupling 226, or screwed into it. The conduit 216 is connected to any conventional water source (not shown) to provide the necessary pressurized water input to the coupling 226, and then to the hollow interior of extension 220 and out the nozzle 40. The pressurized water in conduit 216, and misting from nozzle 40, may be at low, medium, or high pressure. The mist 46 cools the surrounding area, as well as providing moisture to the lawn 202, or other plants in the vicinity.

Thus, FIG. 20 illustrates a landscape or agricultural misting system comprising: An elongated plastic pipe 236 (preferably substantially vertical in use) having a first end (237) for insertion into the ground and a second end with a T-piece (238). An opening (239) in the T-piece opposite the pipe (e.g. extending substantially in the dimension of elongation of the pipe). A conduit (216) capable of transporting water under pressure and having a coupling (226). A misting nozzle (40); and a nozzle extender (220) passing through the opening (239) and having a first end in operative association with the coupling (226) and a second end operatively connected to the nozzle (40), so that water under pressure may pass through the conduit (216), through the coupling (226), into the extender (220), and mist out of the nozzle (40).

While the invention has been herein shown and described in what is presently conceived to be a practical and preferred embodiment thereof, it is to be understood that the invention encompasses a wide variety of modifications and ranges. For example, with respect to the disclosed numerical ranges, all specific ranges within a broad range are specifically provided herein; for example a pressure of about 200-1000 psi includes 500-700, 650-1005, 275-355, and all other specific ranges within the broad range. Therefore the invention is to be accorded the broadest interpretation of the appended claims to encompass all equivalent structures and processes.

What is claimed is:

1. A method of cooling a space or living beings within the space, the space defined at least in part by existing functional elements including at least one substantially liquid-tight passage-containing element, comprising:
a) providing at least one misting nozzle in operative association with the substantially liquid-tight passage-containing element; and
b) supplying liquid under pressure to flow through the existing substantially liquid-tight passage-containing element and confined thereby so that the liquid is supplied as a mist directly into the space through the nozzle to evaporatively cool the space or living beings within the space.

2. A method as recited in claim 1 wherein a) and b) are practiced using a hollow substantially rigid canopy frame component on a watercraft as the substantially liquid-tight passage-containing element.

3. A method as recited in claim 1 wherein a) and b) are practiced using a hollow substantially rigid rail or supporting frame on a watercraft as the substantially liquid-tight passage-containing element.

4. A method as recited in claim 1 wherein b) is practiced by supplying fresh water under a pressure of between about 200-1000 psi.

5. A method as recited in claim 1 wherein a) and b) are practiced to provide a mist of water droplets having a maximum cross-sectional dimension of between about 5-100 microns in the space.

6. A method as recited in claim 1 wherein a) and b) are practiced to provide the mist through a portion of a light fixture.

7. A method as recited in claim 4 wherein a) and b) are practiced to provide the mist through a portion of a light fixture on a watercraft.

8. A method as recited in claim 4 wherein a) and b) are practiced to provide a mist of water droplets having a maximum cross-sectional dimension of between about 5-100 microns in the space.

9. A method of cooling a space, or humans within the space, on a watercraft in an aesthetically acceptable manner, by a) directly misting fresh water into the watercraft space as a mist of water droplets having a maximum cross-sectional dimension of between about 5-100 microns.

10. A method as recited in claim 9 wherein a) is practiced by supplying the water through an unobtrusive nozzle at a pressure of between about 200-1000 psi, and so that the source of the fresh water is not readily visible in the space.

11. A method as recited in claim 10 wherein a) is practiced to direct the mist downwardly into a space covered by a canopy on a deck portion of the watercraft, and wherein a) is further practiced by transporting the water directly through one or more hollow substantially rigid and water-tight frame elements supporting the canopy, and through a plurality of nozzles in communication with the hollow interior of the one or more frame elements.

12. A method as recited in claim 10 wherein when in the space the temperature is above 80 degrees F. and the relative humidity is above 80%, a) is further practiced by chilling the water to a temperature between about 33-50 degrees F., and misting the chilled water into the space.

13. A method as recited in claim 10 wherein a) is practiced by supplying the mist from a plurality of nozzles mounted in a portion of a light fixture of the watercraft.

14. A method as recited in claim 10 wherein a) is practiced by supplying the mist from a plurality of nozzles mounted on at least one of an otherwise functional substantially rigid hollow rail or superstructure frame element of the watercraft.

15. A misting system for supplying a mist of liquid into a space to cool the space or living beings within the space, comprising:
a substantially water-tight passage-containing element which both defines a portion of the space and transports liquid to be misted directly into the space;
a nozzle operatively connected to the substantially water tight element and positioned to supply a mist of liquid from the passage containing element directly into the space; and
a source of liquid under super-atmospheric pressure operatively connected to the passage-containing element.

16. A system as recited in claim 15 mounted on a watercraft to supply a mist of liquid directly toward a deck portion of the watercraft.

17. A system as recited in claim 16 wherein the passage-containing element comprises a component of a frame for supporting a canopy, a rail, a superstructure frame element, or a light fixture.

18. A system as recited in claim 15 wherein said nozzle has at least one orifice with a diameter of between about 0.2-0.5 mm.

19. A system as recited in claim 18 wherein said source of liquid under super-atmospheric pressure comprises a source of fresh water at a pressure of between about 200-1000 psi, and operatively connected through a regulator to said passage-containing element.

20. A system as recited in claim 15 wherein said passage-containing element comprises a substantially rigid and tubular element having a first end mounting said nozzle, a body having an exterior surface with external threading over at least a portion thereof, and a second end operatively connected to said source of liquid under super-atmospheric pressure, said external threading operatively engaging a structural element that in part defines said space.

21. A system as recited in claim 15 wherein said structural element comprises a light fixture substantially annular component, with an open interior of said annular component having an artificial light source therein.

22. A system as recited in claim 21 wherein a plurality of said nozzles are provided, each of which has a screw-threaded end which passes through a passage in said annular component, into a conduit connected to said source of liquid under super-atmospheric pressure.

23. A system as recited in claim 22 wherein said light fixture is on a watercraft.

24. A system as recited in claim 15 wherein a plurality of said nozzles are provided in a ceiling panel, unobtrusively extending downwardly therefrom.

25. A misting system comprising:
a substantially rigid and liquid-tight hollow element capable of withstanding at least 100 psi of liquid flowing therein;
at least one internally threaded opening formed in said element and having a land;
a misting nozzle having an orifice-containing end and a conduit end, said conduit end having a shaft and a ledge, said shaft including an externally threaded portion dimensioned and configured to be screwed threaded into said at least one internally threaded opening;
said misting nozzle externally threaded portion directly operatively engaging said internally threaded opening; and
a seal operatively disposed between said land and said ledge.

26. A system as recited in claim 25 wherein said seal comprises a ring of material which provides a substantially liquid-tight seal between said hollow element and said nozzle.

27. A system as recited in claim 25 wherein said nozzle has at least one orifice with a diameter of between about 0.2-0.5 mm.

28. A system as recited in claim 27 further comprising a source of fresh water at a pressure of between about 200-1000 psi, and operatively connected through a regulator to said hollow element.

29. A system as recited in claim 28 wherein said hollow element comprises a boat canopy frame element, a boat rail, or a boat superstructure element, and wherein said nozzle is positioned to mist water toward a deck area of a boat mounting said hollow element.

30. A system as recited in claim 29 further comprising a plurality of said nozzles operatively connected to said hollow element, each nozzle supplying a mist of water droplets having a maximum cross-sectional dimension of between about 5-100 microns toward said boat deck.

31. A landscape or agricultural misting system comprising: an elongated plastic pipe having a first end for insertion into the ground and a second end with a T-piece, and an opening in said T-piece opposite said pipe; a conduit capable of transporting water under pressure and having a coupling; a misting nozzle; and a nozzle extender passing through said opening and having a first end in operative association with said coupling and a second end operatively connected to said nozzle so that water under pressure passing through said conduit may pass through said coupling, into said extender, and mist out of said nozzle.
